(19) United States
(12) Patent Application Publication
(10) Pub. No.: US 2025/0255428 A1
(43) Pub. Date: Aug. 14, 2025

(54) CENTRIFUGAL CHAMBER WITH CAPSULE OPENING ELEMENTS

(71) Applicant: SOCIETE DES PRODUITS NESTLE S.A., Vevey (CH)

(72) Inventors: MARCEL FANKHAUSER, Toffen (CH); GILLES GAVILLET, Ursy (CH); MIGUEL GORTCHACOW, Lausanne (CH); RUDOLF SCHENK, Konolfingen (CH)

(21) Appl. No.: 18/856,457

(22) PCT Filed: Apr. 13, 2023
(86) PCT No.: PCT/EP2023/059645

§ 371 Date: Oct. 11, 2024

(30) Foreign Application Priority Data
Apr. 14, 2022 (EP) 22168290.9
Dec. 12, 2022 (EP) 22212682.3

(51) Int. Cl. A47J 31/22; A47J 31/36

(52) U.S. Cl. CPC A47J 31/22; A47J 31/3628; A47J 31/3633

(57) ABSTRACT

A machine (1) is configured for preparing a beverage (4) from a flavouring ingredient (5a) supplied within a capsule (5b) in a processing cavity (5) by mixing it with water (4′) and centrifuging them about a processing axis (30′). The machine (1) has a handling system (10,20) including a first ingredient handler (10) and a second ingredient handler (20) that are movable one relative to the other from a capsule transfer configuration to an capsule processing configuration. The handling system (10,20) has (a) beverage outlet(s) (25) and (a) water inlet(s) (24), the outlet(s) (25) and/or the inlet(s) (24) being associated with a capsule opener (24′,25′) having an opening edge (24″,25″) and a capsule opening direction (30″) along which the opening edge (24″,25″) and the capsule (5b) are relatively moved to open the capsule (5b) by the opening edge (24″,25″). The opener (24′,25′) delimits a fluid passage (24a′,24b′,25a′,25b′) located in the opening direction (30″) behind the opening edge (24″,25″).

### FIELD OF THE INVENTION

The field of the invention pertains to beverage preparation machines by centrifuging capsules containing an ingredient of the beverage to be prepared.

For the purpose of the present description, a “beverage” is meant to include any human-consumable liquid substance, such as tea, coffee, hot or cold chocolate, milk, soup, baby food, etc., A “capsule” is meant to include any container such as a packaging for containing a pre-portioned beverage ingredient, e.g. a flavouring ingredient, the packaging forming an enclosure of any material, in particular an airtight or pervious material, porous or non-porous material, e.g. plastic, aluminium, recyclable and/or biodegradable packagings, and of any shape and structure, including soft pods or rigid cartridges for containing the ingredient.

### BACKGROUND ART

Certain beverage preparation machines use capsules containing ingredients to be extracted or to be dissolved and/or ingredients are stored that and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

Brewing devices have been developed to facilitate insertion of a “fresh” capsule and removal of the capsule upon use. Examples of such brewing devices are disclosed in EP 1 646 305, 1 129, 767 WO 2009/043630, WO 2005/004683 and WO 2007/135136, WO 2014/056821. It is known to secure brewing chambers using a hook system, as for example disclosed WO in 2006/005755 and WO 2006/005756.

The opening of capsules using a capsule opener is for example known from EP 0 512 470, EP 2 068 684, WO 02/00073, WO 02/35977, U.S. Pat. Nos. 3,260,190, 5,649,472, CH 605 293, EP 512 468, EP 242 556, WO 2013/026845, WO 2014/076041, WO 2015/022342, WO 2015/022344, WO 2015/022345 and WO 2015/144356.

The preparation of a beverage by using centrifugation is also known. Examples of centrifugation processes and corresponding devices are disclosed in WO 2008/148601, WO2008/148650, U.S. Pat. No. 5,566,605, WO 2013/007776, WO 2013/007779 and WO 2013/007780.

It has also been proposed to facilitate the handling of capsules by systems for extracting them, in particular by motorizing the opening and/or of closure the extraction system for inserting and/or removing a capsule. Examples of such systems are for example disclosed in EP 1 767 129, WO 2009/113035, WO 2012/025258, WO 2012/025259, WO 2012/041605, WO 2013/127476, WO 2014/096122, WO 2014/096123 and EP2015185946.9.

Beverage preparation by centrifugation includes: providing a beverage (flavoring) ingredient, e.g. as powder and/or leaves, in a capsule; circulating liquid into the capsule and rotating the capsule at sufficient speed to ensure interaction of the liquid with the ingredient while creating a gradient of pressure of liquid in the capsule. Such pressure increases gradually from a centre towards a periphery of the capsule and undergo a swirling flow relative to the capsule while extracting the ingredient and forming a liquid extract flowing out at a periphery of the capsule. Examples of such systems are disclosed in WO 2008/148601, WO 2013/007776, WO 2013/007779, WO 2013/007780, WO 2017/046294, WO 2017/068134 and WO 2017/202746. WO 2021/122502 discloses a centrifugal beverage machine with a rotatable valve arrangement for controlling a flow of water towards a centrifugal beverage mixing chamber. The capsule can be secured between facing capsule handlers that are secured by a fastening device, e.g. as disclosed in WO 2012/007293, WO 2013/007776, WO 2013/007779, WO 2013/007780 and WO 2014/102048.

WO 2008/148646 and WO 2008/148650 describe a beverage preparation device wherein a flow restriction is created downstream of the receptacle, in particular a capsule, for example, by a valve which opens or enlarges under the pressure created by the centrifuged liquid leaving the receptacle. The higher the rotational speed, the more the valve opens or enlarges. The valve can be formed by a mobile restriction part of the device which is elastically urged against a rim portion of the capsule. In WO 2017/068134 the centrifugal brewing chamber is fitted with an outlet valve that can be controlled by an inertia body of the machine rotating with the centrifugal brewing chamber. The valve leads into a collector forming a crema chamber in which the beverage upon undergoing a pressure drop at the valve is refined for dispensing into a user-recipient, e.g. a cup or a mug. Such collection chamber is typically arranged around the centrifugal brewing chamber, as for example disclosed in WO 2020/201469.

Capsule centrifugation to prepare coffee has been commercialized under the brand VERTUO® by NESPRESSO®.

It has been proposed to prepare beverages by centrifugation along a horizontal axis.

WO 2015/173123 and WO 2015/173124 disclose a centrifugal brewing chamber formed between two enclosing parts that are relatively translatable between an open position and a closed position. The enclosing parts cooperate with a pair of jaws that are movable between a capsule holding position to hold a capsule between the enclosing in the open position and a capsule release position to release the capsule. The jaws are actuated by a first actuator and a second actuator that are activated by the enclosing parts during their the relative translation. The jaws guide a capsule into a position between the enclosing parts in the open position and immobilize the capsule thereinbetween. Then, when the enclosing parts are translated together to enclose the capsule, the jaws release the capsule so that the brewing chamber is formed about the capsule. The enclosing parts are rotated about a horizontal axis to centrifuge the capsule for preparing the beverage with the ingredient in the capsule. At the end of beverage preparation, centrifugation stops and the enclosing parts are relatively translated to the open position whereby the used capsule is allowed to drop from the enclosing parts. Then the jaws are brought back into their capsule holding position. Further centrifugal beverage machines are disclosed in EP2021201687.7, EP2021202356.8, EP2021216919.7, EP2021216927.0, EP2021216930.4, EP 21216965.0, EP2021216970.0 and EP2021216976.7.

### SUMMARY OF THE INVENTION

The invention relates to a machine for preparing a beverage from at least one ingredient. Normally such beverage is then dispensed to a user, e.g. to a user-cup or user-mug.

For instance, the machine coffee, is a tea, chocolate, cacao, milk or soup preparation machine. For example, the machine is arranged for preparing within a beverage processing module that includes an ingredient holder, a beverage by passing hot or cold water or another liquid through the ingredient held in the holder, such as a flavouring ingredient, of the beverage to be prepared, such as ground coffee or tea or chocolate or cacao or milk powder.

Such beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluent liquid, e.g. water, may be mixed with such ingredient to form the beverage. Typically, a predetermined amount of beverage is formed and dispensed on user-request, which corresponds to a portion (e.g. a serving). The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . . For example, a coffee machine may be configured for dispensing espressos, e.g. an adjustable volume of 20 to 60 ml per serving, and/or for dispensing lungos, e.g. a volume in the range of 70 to 200 ml per serving, and/or for dispensing americanos, e.g. a volume in the range of 150 to 750 ml.

An aspect of the invention relates to a machine for beverage from a flavouring ingredient, preparing a supplied within a capsule in a processing cavity. The ingredient is mixed with water in the capsule. The ingredient and water are centrifugally driven about a processing axis to form the beverage.

The centrifugation process for preparing a beverage is known for example from EP 2 000 062, EP 2 155 020, EP 2 152 128, WO 2008/148646, WO 2009/106175, WO 2009/106589, WO 2010/026045, WO 2010/026053, WO 2010/066736, WO 2008/148650, WO 2008/148834, WO 2010/066705, WO 2010/063644, WO 2011/023711, WO 2014/096122 or WO 2014/096123.

Typically, the machine includes one or more of the following components:
a) a fluid system in fluid communication with the flavouring ingredient during beverage preparation;
b) a thermal conditioner, such as in-line heater and/or cooler, for thermally conditioning a flow of liquid circulated to the flavouring ingredient or a batch thermal conditioner for circulating thermally conditioned liquid from the batch conditioner to the flavouring ingredient;
c) a liquid driver, such as a pump, for driving liquid to the flavouring ingredient, in particular a low pressure pump e.g. within the range of 1 to 5 bar, such as 1.5 to 3 bar;
d) a motor for driving the flavouring ingredient in rotation during beverage preparation;
e) an electric control unit, in particular comprising a printed circuit board (PCB), for receiving instructions from a user via an input user-interface and for controlling the thermal conditioner, liquid driver and motor(s); and
f) one or more sensors for sensing at least one characteristic selected from characteristics of fluid system, the thermal conditioner, the liquid driver, a liquid tank, an ingredient collector, a flow of the liquid (e.g. by a flowmeter), a pressure of the liquid and a temperature of the liquid, and for communicating such characteristic(s) to the control unit.

The abovementioned capsule may have a body containing the ingredient and a peripherally projecting flange, e.g. a body in the shape of a cup and a lid covering the mouth of the cup and extending beyond the mouth to form the peripherally projecting flange.

The capsule may have a body that is symmetric or asymmetric, conical or frusto-conical or cylindrical or spherical or hemispherical or frusto-spherical, containing the ingredient, e.g. ground coffee, tea or cacao or another beverage ingredient.

The capsule may be of the type described above under the header “field of the invention”. The capsule may be a capsule that has a container-body, e.g. a generally cup-shaped or hemispherical or hemi-ellipsoidal body, having a flange to which a cover lid (or membrane) is attached, in particular sealed. Typically the capsule contains a beverage ingredient. Examples of suitable capsules are disclosed in WO 2008/148601, WO 2008/148604, WO 2008/148646, WO 2008/148650, WO 2008/148656, WO 2008/148834, WO2011/141532, WO 2011/141535, WO 2013/072239, WO 2013/072297, WO 2013/072326, WO 2015/044400. The capsule may be of the variety commercialised by Nespresso under the brand Vertuo.

The machine has a rotatable ingredient handling system for holding the capsule and rotating the flavouring ingredient and water during centrifugation about the processing axis. The ingredient handling system has at least one beverage outlet and at least one water inlet for supplying water to the ingredient. The system has a first ingredient handler and a second ingredient handler that are movable one relative to the other from:
an ingredient transfer configuration for receiving the ingredient within the capsule by the first and second capsule handlers and/or releasing the capsule from the first and second ingredient handlers; to
an ingredient processing configuration for centrifuging the ingredient and water within the capsule by rotation about the processing axis;
and vice versa.

Upon processing, the capsule may be collected in a capsule collector downstream the handling system, as for example disclosed in WO 2009/074559 or WO 2009/135869.

The machine has a machine frame and/or housing which is stationary when the ingredient handling system is rotated for centrifugation and which supports the ingredient handling system. For example, the first and second handlers are mounted in rotation on the frame and/or housing via one or more bearings, such as ball bearings.

One or more of the beverage outlet(s) and the water inlet(s) are associated with one or more capsule openers, such as capsule piercers.

At least one such opener of the capsule openers having an opening edge and a capsule opening direction along which at least one such opening edge and the capsule are relatively moved to open the capsule by the opening edge when the capsule is received by the first and second ingredient handlers. For example, the opening direction is parallel or substantially parallel to the processing axis.

At least one opener delimits a fluid passage located in the opening direction behind the opening edge, optionally the opening edge forming a single ramp that has height that increases against a direction of rotation of the opening edge about the processing axis during the centrifugation.

During rotation of the handling system, the water and flavouring ingredient is centrifuged in the processing cavity about the processing axis. The water supplied into the cavity is centrifuged about the processing axis at the water inlet(s).

The water supplied to the cavity and the water and ingredient mixed in the cavity are all centrifuged, leading to a rotational flow of the water whereby water and beverage ingredient are typically subjected to a radial pressure direction relative to the processing axis.

The fluid flowing within the cavity near the opener will typically have a significant circumferential velocity component relative to the cavity. Such circumferential velocity component increases with an increase of rotational speed. The circumferential velocity component at the opening (and possibly the pressure gradient) cooperating with the asymmetric shape and orientation of the opener in the circumferential direction to affect the filtering of the flavouring ingredient at the opening formed by the capsule openers in the capsule.

The fluid may typically pass in a manner that is asymmetrical (in a circumferential direction) about the opener behind the opening edge under the effect of centrifugation, the opener face delimiting the fluid passage, it directs the flow and/or exercise a counter-pressure. For instance, the opener face is asymmetric in the circumferential direction, such as tilted or inclined along the circumference direction.

A direction of tilting or inclination of the opener may significantly affect the filtering of the favouring ingredient under a given direction of rotation. Typically, openers tilted or inclined clockwise will have significantly different filtering effect to openers a tilted or inclined counter-clockwise.

This affects the relationship between the water and the flavouring ingredient on the one hand, generating different preferential paths therefor, as well as the nature of the flow of the supplied water, e.g. turbulences or flow linearity. As a consequence, the asymmetry of the passage relative to the opener affects the flow of water and flavouring ingredient as well as the incoming flow of water. For instance, the spreading of the distribution of the water flowing via the inlet into the cavity is affected and/or turbulence in this water flow can be promoted (or inhibited). The flow path of the water and the flavouring ingredient towards the outlet can be affected to either solid separate ingredient (e.g. coffee fines) from the water (increase the filtering effect) or, conversely, canalising solid ingredient and the water to reduce the filtering. Hence, better control a of the extraction process can be achieved to obtain a desired in-cup result.

The rotatable ingredient handling system can be configured to be centrifugally driven at sufficient speed so that water circulated into the capsule together with the ingredient undergo a pressure increasing gradually from a centre towards a periphery of the capsule and undergo a swirling flow relative to the capsule while extracting the ingredient and forming a liquid extract flowing out at a periphery of the capsule.

Such swirl may affect the filtering of coffee fines and grounds.

The machine may incorporate a liquid driver for driving water, e.g. from a source such as a water tank or a domestic water distribution network, to the flavouring ingredient, typically a pump. Such pump can be a low pressure pump, e.g. within the range of 1 to 5 bar, such as 1.5 to 3 bar.

The fluid passage can be recessed in the at least one opener asymmetrically about the opener relative to the opening direction, e.g. in a circumferential direction relative to the processing axis behind the opening edge.

The fluid passage may be recessed in the at least one opener in a direction that is radial relative to the processing axis behind the opening edge.

The at least one opener can have a proximate side face that is radially proximate to the processing axis and a distant side face that is radially distant to the processing axis, the fluid passage being delimited by the distant side face or by the proximate side face.

The fluid passage may be recessed into the at least one opener in a direction that is annular relative to the processing axis behind the opening edge.

The at least one opener can have a front side face that forms a front of the opener during rotation of the ingredient handling system and can have a back side face that forms a back of the opener during rotation of the ingredient handling system, the fluid passage being delimited by the front side face or by the back side face.

The fluid passage may be formed as a recess in the at least one opener by at least one of: bending the opener; machining the opener; and moulding the opener.

One or more openers may combine one or more of the above described fluid passages.

The machine frame and/or housing can delimit an ingredient supply passage configured to allow supply by gravity of the ingredient within the capsule towards the rotatable ingredient system and handling a waste evacuation passage configured to allow an evacuation by gravity of waste, e.g. a used capsule, from the rotatable ingredient handling system.

The supply passage may be provided with a guide for guiding the capsule. The guide may be configured to cooperate with a complementary capsule shape e.g. a capsule flange. The guide can form a recess and/or a rail. The guide may be associated with a capsule stop configured to immobilize the capsule at a level between the first and second ingredient handlers e.g. substantially coaxially with the processing axis. The stop, e.g. a capsule retainer, can be fixed to or integral with the guide.

The guide or a portion of the guide may be mounted movably towards and away from the processing axis.

The supply passage can be provided with two such guides facing each other so that the capsule is guided between the guides.

The guide or a portion thereof can be integral with or fixed to an elastic arm movable, e.g. movable by flexion, between an immobilization position for immobilizing the capsule at the level between the first and second ingredient handlers by the stop and a release position for releasing the capsule from the stop.

The stop can be configured to be urged into the holding position or into the release position by at least one of the first and second ingredient handlers movably mounted relative to the stop.

The stop may be located at or towards one end of the elastic arm, the elastic arm having an opposite end at or towards which opposite end the arm is secured to the machine frame and/or or housing to the rotatable ingredient handling system.

The elastic arm can be: substantially wire-shaped and/or blade-shaped; and/or made of metal, e.g. steel, and/or plastic material.

The machine may include a handler actuator, such as a motor or a user-handle, configured to relatively move the first and second capsule handlers between the transfer and the processing configurations. The machine can have at least one fastener movable selectively into a fastening position to fasten together the first and second capsule handlers in the processing configuration and into an unfastening position in which the first and second capsule handlers are movable from the processing configuration to the transfer configuration and/or vice versa. The fastener can be actuated by the handler actuator into the fastening position and/or into the unfastening position. The fastener may be biased into the fastening position or into the unfastening position e.g. by an elastic member e.g. elongated arm.

The handler actuator may be angularly stationary relative to the frame and/or housing about the processing axis when the ingredient handling system is rotated for centrifugation.

When present, the fastener can be angularly stationary relative to the first ingredient handler and/or second ingredient handler about the processing axis, e.g. when the ingredient handling system is rotated for centrifugation.

The machine may include a fastener lock configured to lock the fastener in the fastening position and to unlock the fastener such that the fastener moves and/or is movable into the unfastening position. For example, the fastener lock is angularly stationary relative to the fastener about the processing axis when e.g. the ingredient handling system is rotated for centrifugation.

The handler actuator can be configured to drive the fastener lock from: a fastener unlocking position into a locking position once the first and second fastener capsule handlers have been relatively moved by the handler actuator into the processing configuration; and/or a fastener locking position into a fastener unlocking position before the first and second capsule handlers are relatively moved by the handler actuator out of the processing configuration towards the transfer configuration.

The handler actuator may be configured to drive the fastener lock via a transmission is that angularly stationary relative to the frame and/or housing about the processing axis when the ingredient handling system is rotated for centrifugation. For example, the transmission is movable in translation to drive the fastener lock between its fastener unlocking position and its fastener locking position, e.g. the transmission being movable in parallel to the processing axis.

The machine may incorporate a plurality of fasteners distributed around the processing axis, e.g. peripherally about at least one of the first and second capsule handlers. The fasteners can be integral with or fixed to or assembled to a base.

The base may extend peripherally at least partly around one of the first and second capsule handlers.

The base can be connected to the fasteners by at least one corresponding elastic member. For example each fastener is connected to the base by a corresponding elastic member whereby each elastic member connects to the base one, two or at most three fasteners.

The machine may include a beverage passage, e.g. a beverage conduit, in fluid communication with the beverage outlet, the passage being configured to guide the beverage from towards the outlet a beverage dispensing outlet. The passage can be associated with a valve, such as a centrifugal and/or electric valve, for controlling the flow and/or the pressure of the beverage along the beverage passage.

The machine may include a beverage conditioner delimiting a conditioning e.g. between cavity, two surfaces that are movable relatively to one another e.g. rotatably movable. The conditioning cavity may be fluidically connected with the beverage passage. The conditioning cavity can be configured to refine the beverage supplied from the beverage outlet via the beverage passage. The valve may be fluidically located between the beverage outlet and the conditioning cavity.

The frame and/or housing may include or be fixed to a bottom configured to rest on a support surface external to such machine when the ingredient handling system is rotated about the processing axis for centrifugation, e.g. an external support surface formed by a table top. The processing axis can be at an angle relative to such bottom in the range of 0° to 60°, for instance of 0° to 45°, such as of 0° to 30°, e.g. of 0° to 15°, typically of substantially 0°.

The frame and/or housing can support a motor that is connected to the ingredient handling system, for instance connected directly or via a transmission, such as at least one of belts e.g. toothed belts, gears e.g. spur gears, and connecting rods.

The processing cavity may have a plurality of beverage outlets peripherally arranged at the processing cavity about the central processing axis and/or may have the water inlet located at the processing cavity on or adjacent to the processing axis.

The invention also relates to a system comprising a machine as described above and the capsule containing the flavouring ingredient.

A further aspect of the invention relates to a method of preparing in the above described machine the beverage from the flavouring ingredient supplied within the capsule into the machine.

Another aspect of the invention concerns the use of a capsule as the capsule for: being handled by a machine as described above; implementing the system as described above; or carrying out the method as described above.

In such use or in the abovementioned method, the capsule:
is supplied between the first and second ingredient handlers in the transfer configuration;
is brought with the first and second ingredient handlers to the ingredient processing configuration by relatively moving the handlers into the ingredient processing configuration;
is opened by the opener(s) associated with the beverage outlet(s) and the water inlet(s) so that the opener(s) delimit(s) a fluid passage located in the opening direction behind the opening edge of the at least one opener;
is fed in the processing cavity with the water by feeding it via the water inlet into the capsule in the processing cavity, the flavouring ingredient with the water being centrifuged and forming the beverage;
releases the beverage via the beverage outlet and the beverage passage; and
is released from the first and second handlers by relatively moving the first and second ingredient handlers from the ingredient processing configuration to the ingredient transfer configuration.

### BRIEF DESCRIPTION OF THE DRAWINGS

The invention will now be described with reference to the schematic drawings, wherein:

FIG. 1 is a cross-sectional side view of part of a machine that has a rotatable ingredient handling system and at least one capsule opener according to an embodiment of the invention;

FIG. 2 is a cross-sectional side view of part of the handling system of the machine of FIG. 1, the handling system being in the ingredient transfer configuration;

FIG. 3 is a cross-sectional side view of part of the handling system of the machine of FIG. 1, the handling system being in the ingredient processing configuration without any ingredient capsule;

FIG. 4 is a cross-sectional side view of the handling system of the machine of FIG. 1, the handling system being in the ingredient processing configuration with an ingredient capsule;

FIG. 5 is a perspective view of fasteners of the exemplary machine of FIG. 1;

FIG. 6 is a cross-sectional view from above of the handling system of the exemplary machine of FIG. 1, the handling system having a pair of guides in the immobilization position, each guide being associated with a capsule stop;

FIG. 7 is a cross-sectional view from above of the handling system of the machine of FIG. 1, the handling system being in the processing configuration without any ingredient capsule;

FIG. 8 is a cross-sectional side view of part of the machine of FIG. 1, the handling system being in the ingredient processing configuration and holding a capsule, the machine having a beverage conditioner and a thermal conditioner;

FIG. 9 shows the guides in the immobilization position of the machine shown in FIG. 6 with a capsule;

FIG. 10 shows the guides in the release position of the machine shown in FIGS. 7 and 8 without a capsule;

FIG. 11 is a perspective view of an ingredient handler fitted with beverage outlets and corresponding capsule openers as well as a water inlet with corresponding capsule openers, the capsule openers of the beverage outlets being bent towards the processing axis (radially) to provide openings increased in size in the capsule at the level of the openers;

FIG. 12 is a perspective view of several capsule openers (alternative to the ones shown in FIG. 11) to be associated with one or more beverage outlets, the capsule openers being bent tangentially (or annularly) about the processing axis to provide openings increased in size in the capsule at the level of the openers;

FIG. 13 is a perspective view of several capsule openers (as an alternative to the ones shown in FIG. 11) associated with a water inlet, the capsule openers having relative to the processing axis a radially narrowed cross-section at a level of a capsule upon opening of the capsule to provide openings increased in size in the capsule at the level of the openers; and

FIG. 14 is a perspective view of several capsule openers (as an alternative to the ones shown in FIGS. 11 and 13) associated with a water inlet, the capsule openers having relative to the processing axis a tangentially (or annularly) narrowed cross-section at a level of a capsule upon opening of the capsule to provide openings increased in size in the capsule at the level of the openers.

### DETAILED DESCRIPTION

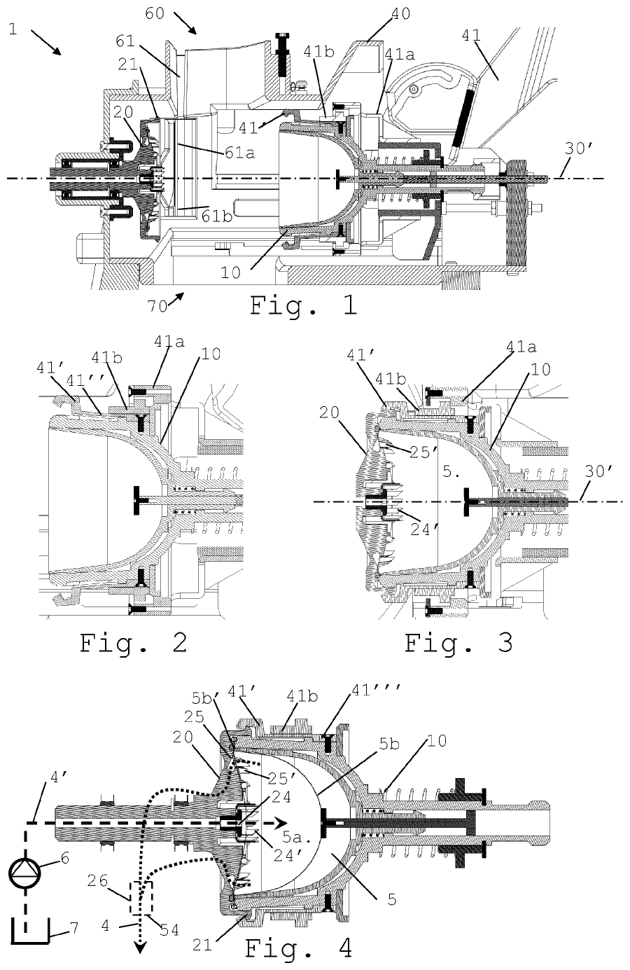

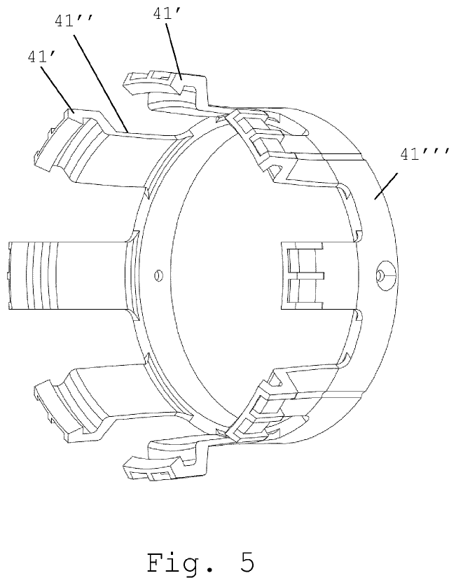

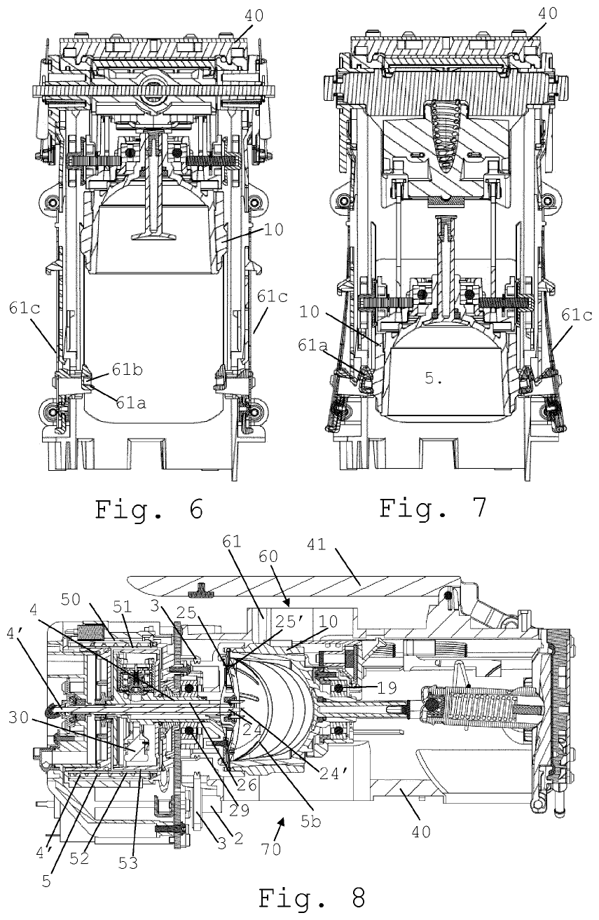

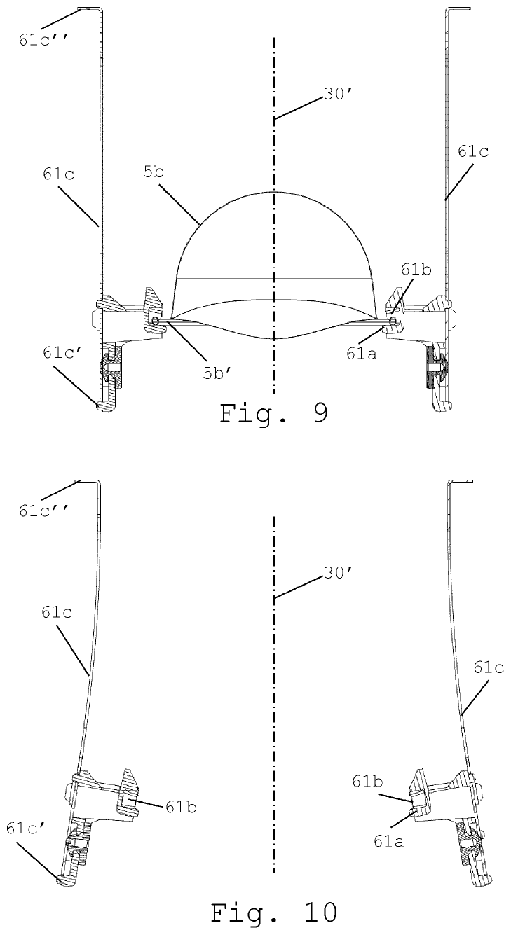

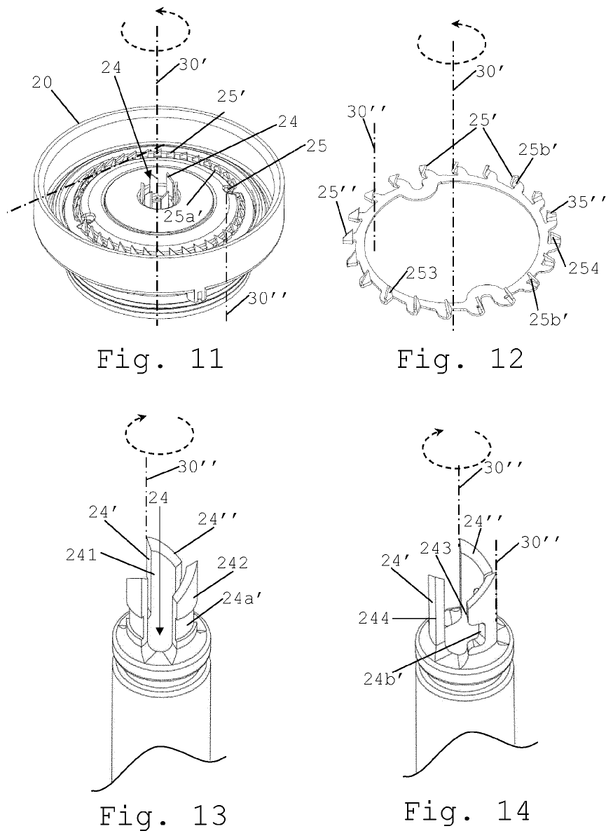

FIGS. 1 to 14 illustrate an exemplary embodiment of part of a machine 1 in accordance with the invention as well as components and variations thereof.

Machine 1 is configured for preparing a beverage 4 from a flavouring ingredient 5a supplied within a capsule 5b in a processing cavity 5. Ingredient 5a is mixed with water 4′ in capsule 5b. Ingredient 5a and water 4′ are centrifugally driven about a processing axis 30′ to form beverage 4.

Machine 1 includes a rotatable ingredient handling system 10,20 for holding capsule 5b and rotating flavouring ingredient 5a and water during centrifugation about processing axis 30′. Ingredient handling system 10,20 has at least one beverage outlet 25 and at least one water inlet 24 for supplying water 4′ to ingredient 5a. System 10,20 has a first ingredient handler 10 and a second ingredient handler 20 that are movable one relative to the other from:
an ingredient transfer configuration for receiving ingredient 5a within capsule 5b by first and second capsule handlers 10,20 and/or releasing capsule 5b from first and second ingredient handlers 10,20; to
an processing configuration for ingredient centrifuging ingredient 5a and water 4′ within capsule 5b by rotation about processing axis 30′;
and vice versa.

Machine 1 has a machine frame and/or housing 40 which is stationary when ingredient handling system 10,20 is rotated for and centrifugation which supports ingredient handling system 10,20. For example, first and second handlers 10,20 are mounted in rotation on frame and/or housing 40 via one or more bearings 19, 29, such as ball bearings.

One or more of beverage outlet(s) 25 and water inlet(s) 24 is/are associated with one or more capsule openers 24′,25′, such as capsule piercers 24′,25′.

At least one opener 24′,25′ of capsule openers 24′,25′ has an opening edge 24″,25″ and a capsule opening direction 30″ along which such at least one opening edge 24″,25″ and capsule 5b are relatively moved to open capsule 5b by opening edge 24″, 25″ when capsule 5b is received by first and second ingredient handlers 10,20. Opening direction 30″ may be parallel or substantially parallel to processing axis 30′.

At least one opener 24′,25′ delimits a fluid passage 24a′, 24b′, 25a′, 25b′ located in opening direction 30″ behind opening edge 24″,25″.

Opening edge 24″, 25″ may form a single ramp that has a height that increases against a direction of rotation of opening edge 24″,25″ about processing axis 30′ during the centrifugation.

Rotatable ingredient handling system 10,20 may be configured to be centrifugally driven at sufficient speed so that water 4′ circulated into capsule 5b together with ingredient 5a undergo a pressure increasing gradually from a centre towards a periphery of capsule 5b and undergo a swirling flow relative to capsule 5b while extracting ingredient 5a and forming a liquid extract flowing out at a periphery of capsule 5b.

Machine 1 typically includes a liquid driver 6 for driving water 4′, e.g. from a source 7 such as a water tank or a domestic water distribution network, to flavouring ingredient 5a. For example, liquid driver 6 is or comprises a pump, for instance a low pressure pump, e.g. within the range of 1 to 5 bar, such as 1.5 to 3 bar.

Fluid passage 24a′, 24b′, 25a′, 25b′ can be recessed in the above at least one opener 24′,25′ asymmetrically about opener 24′,25′ relative to opening direction 30″.

Fluid passage 24a′ may be recessed in the abovementioned at least one opener 24′ in a direction that is radial relative to processing axis 30′ behind opening edge 24″.

The abovementioned at least one opener 24′,25a′ may have a proximate side face 241,251 that is radially proximate to the processing axis 30′ and a distant side face 242,252 that is radially distant to processing axis 30′, fluid passage 24a′, 25a′ being delimited by distant side face 242 or by proximate side face 251.

Fluid passage 24b′, 25b′ can be recessed into the abovementioned at least one opener 24′,25′ in a direction that is annular relative to processing axis 30′ behind opening edge 24″.

The abovementioned at least one opener 24′,25′ can have a front side face 243,253 that forms a front of opener 24′,25′ during rotation of ingredient handling system 10,20 and can have a back side face 244,254 that forms a back during of opener 24′,25′ rotation of ingredient handling system, fluid passage 24b′ 25b′ being delimited by front or back side face 243, 254.

Fluid passage 24a′, 24b′, 25b′ can be formed as a recess in the abovementioned at least one opener 24′,25′ by at least one of: bending opener 25′,25b′ (e.g. pre-formed as a plate or blade); machining opener 24′,24a′; and moulding opener 24′,24b′.

Machine frame and/or housing 40 can delimit an ingredient supply passage 60 configured to allow supply by gravity of ingredient 5a within capsule 5b towards the rotatable ingredient handling system 10, 20 and can delimit a waste evacuation passage 70 configured to allow an evacuation by gravity of waste, e.g. a used capsule 5b, from rotatable ingredient handling system 10,20.

Supply passage 60 may be provided with a guide 61, 61a for guiding capsule 5b. Guide 61, 61a can be configured to cooperate with a complementary capsule shape e.g. a capsule flange 5b′. Guide 61, 61a may form a recess and/or a rail. Guide 61, 61a can be associated with a capsule stop 61b configured to immobilize capsule 5b at a level between first and second ingredient handlers 10,20 e.g. substantially coaxially with the processing axis 30′. For example, the stop 61b, e.g. a capsule retainer, is fixed to or integral with guide 61, 61a. Guide or a portion 61a thereof may be mounted movably towards and away from processing axis 30′.

Supply passage 60 may be provided with two such guides 61, 61a facing each other so that capsule 5b is guided between guides 61,61a.

Guide or a portion 61a thereof may be integral with or fixed to an elastic arm 61c movable, e.g. movable by immobilization position for flexion, between an immobilizing capsule 5b at the level between first and second ingredient handlers 10,20 by stop 61b and a release position for releasing capsule 5b from stop 61b.

Stop 61b may be configured to be urged into the holding position or into the release position by at least one of first and second ingredient handlers 10, 20 movably mounted relative to stop 61b.

Stop 61b can be located at or towards one end 61c′ of elastic arm 61c. Elastic arm 61c can have an opposite end 61c″ at or towards which opposite end 61c″ arm 61c is secured to machine frame and/or housing 40 or to rotatable ingredient handling system 10,20.

Elastic arm 61c may be: substantially wire-shaped and/or blade-shaped; and/or made of metal, e.g. steel, and/or plastic material.

Machine 1 may include a handler actuator 41, such as a motor or a user-handle, configured to relatively move first and second capsule handlers 10,20 between transfer and processing configurations.

Machine 1 can have at least one fastener 41′ movable selectively into a fastening position to fasten together first and second capsule handlers 10,20 in the processing configuration and into an unfastening position in which first and second capsule handlers 10,20 are movable from the processing configuration to the transfer configuration and/or vice versa. Fastener 41′ can be actuated by handler actuator 41 into the fastening position and/or into the unfastening position. Fastener 41′ may be biased into the fastening position or into the unfastening position for example by an elastic member 41″ e.g. elongated arm.

Handler actuator 41 may be angularly stationary relative to frame and/or housing 40 about processing axis 30′ when ingredient handling system 10,20 is rotated for centrifugation.

When present, fastener 41′ may be angularly stationary relative to first ingredient handler 10 and/or second ingredient handler 20 about processing axis 30′, e.g. when ingredient handling system 10,20 is rotated for centrifugation.

Machine 1 may include a fastener lock 41b configured to lock fastener 41′ in the fastening position and to unlock fastener 41′ such that fastener 41′ moves and/or is movable into the unfastening position. Fastener lock 41b can be angularly stationary relative to fastener 41′ about processing axis 30′, e.g. when handling system 10,20 is rotated for centrifugation.

Handler actuator 41 may be configured to drive fastener lock 41b from:
a fastener unlocking position into a fastener locking position once first and second capsule handlers 10,20 have been relatively moved by handler actuator 41 into the processing configuration; and/or
a fastener locking position into a fastener unlocking position before first and second capsule handlers 10, 20 are relatively moved by handler actuator 41 out of the processing configuration towards the transfer configuration.

Handler actuator 41 can be configured to drive fastener lock 41b via a transmission 41a that is angularly stationary relative to frame and/or housing 40 about processing axis 30′ when ingredient handling system 10,20 is rotated for centrifugation. Transmission 41a may be movable in translation to drive fastener lock 41b between its fastener unlocking position and its fastener locking position, e.g. transmission 41a being movable in parallel to processing axis 30′.

Machine 1 may include a plurality of fasteners 41′ distributed around processing axis 30′, e.g. peripherally about at least one of first and second capsule handlers 10, 20. Fasteners 41′ can be integral with or fixed to or assembled to a base 41′″

Base 41′″ may extend peripherally at least partly around one of first and second capsule handlers 10,20.

Base 41′″ can be connected to the fasteners 41′ by at least one corresponding elastic member 41″. Each by fastener 41′ may be connected to base 41′″ a corresponding elastic member 41″ whereby each elastic member 41″ connects to base 41′″ one, two or at most three fasteners 41′.

Machine 1 can have a beverage passage 26, e.g. a beverage conduit, in fluid communication with beverage outlet 25, passage 26 being configured to guide beverage 4 from outlet 25 towards a beverage dispensing outlet 54. Passage 26 may be associated with a valve 30, such as a centrifugal and/or electric valve, for controlling the flow and/or the pressure of beverage 4 along beverage passage 26.

Machine 1 may include a beverage conditioner 50 delimiting a conditioning cavity 51, e.g. between two surfaces 52,53 that are movable relatively to one another e.g. rotatably movable. Conditioning cavity 51 may be fluidically connected with beverage passage 26. Conditioning cavity 51 can be configured to refine beverage 4 supplied from beverage outlet 25 via beverage passage 26. Valve 30 can be fluidically located between beverage outlet 25 and conditioning cavity 51.

Frame and/or housing may incorporate or be fixed to a bottom configured to rest on a support surface external to machine 1 when ingredient handling system 10,20 is rotated about processing axis 30′ for centrifugation. External support surface may be formed by a table top. Processing axis 30′ can be at an angle relative to such bottom in the range of 0° to 60°, for instance of 0° to 45°, such as of 0° to 30°, e.g. of 0° to 15°, typically of substantially 0°.

Frame and/or housing may support a motor 2 that is connected to ingredient handling system 10,20, for instance connected directly or via a transmission 3, such as at least one of belts e.g. toothed belts, gears e.g. spur gears, and connecting rods.

Processing cavity 5 may have a plurality of beverage outlets 25 peripherally arranged at processing cavity 5 about central processing axis 30′.

Processing cavity 5 can have water inlet 24 located at processing cavity 5 on or adjacent to processing axis 30′.

For operating machine 1, the following steps are carried out:
supplying capsule 5b between first and second ingredient handlers 10,20 in the ingredient transfer configuration;
relatively moving first and second ingredient handlers 10,20 with capsule 5b from the transfer configuration to the ingredient processing configuration;
opening capsule 5b with capsule opener(s) 24′,25′ associated with beverage outlet(s) 25 and/or water inlet(s) 24 so that at least one such opener 24′,25′ delimits a fluid passage 24a′, 24b′, 25a′, 25b′ located in behind opening direction 30″ opening edge 24″,25″ of at least one such opener 24′,25′;
feeding water 4′ via water inlet 24 into capsule 5b in processing cavity 5 and centrifuging flavouring ingredient 5a with water 4′ and forming beverage 4;
releasing beverage 4 from capsule 5b via beverage outlet 25 and beverage passage 26; and
relatively moving first and second ingredient handlers 10,20 into the ingredient transfer configuration and evacuating capsule 5b.

1. A machine for preparing a beverage from a flavouring ingredient supplied within a capsule in a processing cavity by mixing said ingredient with water in said capsule and centrifugally driving such ingredient and said water about a processing axis to form said beverage, such machine comprising:
a rotatable ingredient handling system for holding said capsule and rotating said flavouring ingredient and water during centrifugation about the processing axis, the ingredient handling system having at least one beverage outlet and at least one water inlet for supplying said water to said ingredient, the system having a first ingredient handler and a second ingredient handler that are movable one relative to the other from:
an ingredient transfer configuration for receiving said ingredient within said capsule by the first and second capsule handlers and/or releasing said capsule from the first and second ingredient handlers; to
an ingredient processing configuration for centrifuging said ingredient and water within said capsule by rotation about the processing axis;
and vice versa;
and
a machine frame and/or housing which is stationary when the ingredient handling system is rotated for centrifugation and which supports the ingredient handling system,
one or more of the beverage outlet(s) and the water inlet(s) being associated with one or more capsule openers, such as capsule piercers;
at least one opener of said capsule opener(s) having an opening edge and a capsule opening direction along which said at least one opening edge and said capsule are relatively moved to open said capsule by the opening edge when said capsule is received by the first and second ingredient handlers,
at least one opener delimits a fluid passage located in the opening direction behind the opening edge.

2. The machine of claim 1, wherein the rotatable ingredient handling system is configured to be centrifugally driven at sufficient speed so that water circulated into said capsule together with the ingredient undergo a pressure increasing gradually from a centre towards a periphery of the capsule and undergo a swirling flow relative to the capsule while extracting the ingredient and forming a liquid extract flowing out at a periphery of the capsule.

3. The machine of claim 1, which comprises a liquid driver for driving water to the flavouring ingredient, typically a pump, for instance a low pressure pump.

4. The machine of claim 1, wherein the fluid passage is recessed in said at least one opener asymmetrically about the opener relative to the opening direction.

5. The machine of claim 1, wherein the fluid passage is recessed in said at least one opener in a direction that is radial relative to said processing axis behind the opening edge.

6. The machine of claim 5, wherein said at least one opener has a proximate side face that is radially proximate to the processing axis and a distant side face that is radially distant to the processing axis, the fluid passage being delimited by the distant side face or by the proximate side face.

7. The machine of claim 1, wherein the fluid passage is recessed into said at least one opener in a direction that is annular relative to said processing axis behind the opening edge.

8. The machine of claim 7, wherein said at least one opener has a front side face that forms a front of the opener during rotation of the ingredient handling system and has a back side face that forms a back of the opener during rotation of the ingredient handling system, the fluid passage being delimited by the front side face or by the back side face.

9. The machine of claim 1, wherein the fluid passage is formed as a recess in said at least one opener by at least one of: bending the opener; machining the opener; and moulding the opener.

10. The machine of claim 1, wherein the machine frame and/or housing delimits an ingredient supply passage configured to allow supply by gravity of said ingredient within said capsule towards the rotatable ingredient handling system and a waste evacuation passage configured to allow an evacuation by gravity of waste,
the supply passage being provided with a guide for guiding said capsule, the guide being configured to cooperate with a complementary capsule shape, the guide forming for instance a recess and/or a rail, the guide being associated with a capsule stop configured to immobilize said capsule at a level between the first and second ingredient handlers.

11. The machine of claim 1, which comprises a beverage passage in fluid communication with the beverage outlet, the passage being configured to guide said beverage from the outlet towards a beverage dispensing outlet.

12. The machine of claim 11, which comprises a beverage conditioner delimiting a conditioning cavity, the conditioning cavity being configured to refine said beverage supplied from the beverage outlet via the beverage passage, the valve being for instance fluidically located between the beverage outlet and the conditioning cavity.

13. A system comprising a machine for preparing a beverage from a flavouring ingredient supplied within a capsule in a processing cavity by mixing said ingredient with water in said capsule and centrifugally driving such ingredient and said water about a processing axis to form said beverage, such machine comprising:
a rotatable ingredient handling system for holding said capsule and rotating said flavouring ingredient and water during centrifugation about the processing axis, the ingredient handling system having at least one beverage outlet and at least one water inlet for supplying said water to said ingredient, the system having a first ingredient handler and a second ingredient handler that are movable one relative to the other from:
an ingredient transfer configuration for receiving said ingredient within said capsule by the first and second capsule handlers and/or releasing said capsule from the first and second ingredient handlers; to
an ingredient processing configuration for centrifuging said ingredient and water within said capsule by rotation about the processing axis;
and vice versa;
and
a machine frame and/or housing which is stationary when the ingredient handling system is rotated for centrifugation and which supports the ingredient handling system,
one or more of the beverage outlet(s) and the water inlet(s) being associated with one or more capsule openers, such as capsule piercers;
at least one opener of said capsule opener(s) having an opening edge and a capsule opening direction along which said at least one opening edge and said capsule are relatively moved to open said capsule by the opening edge when said capsule is received by the first and second ingredient handlers,
at least one opener delimits a fluid passage located in the opening direction behind the opening edge and said capsule containing said flavouring ingredient.

14. A method of preparing in a machine a beverage from a flavouring ingredient supplied within a capsule in a processing cavity by mixing said ingredient with water in said capsule and centrifugally driving such ingredient and said water about a processing axis to form said beverage, such machine comprising:
a rotatable ingredient handling system for holding said capsule and rotating said flavouring ingredient and water during centrifugation about the processing axis, the ingredient handling system having at least one beverage outlet and at least one water inlet for supplying said water to said ingredient, the system having a first ingredient handler and a second ingredient handler that are movable one relative to the other from:
an ingredient transfer configuration for receiving said ingredient within said capsule by the first and second capsule handlers and/or releasing said capsule from the first and second ingredient handlers; to
an ingredient processing configuration for centrifuging said ingredient and water within said capsule by rotation about the processing axis;
and vice versa;
and
a machine frame and/or housing which is stationary when the ingredient handling system is rotated for centrifugation and which supports the ingredient handling system,
one or more of the beverage outlet(s) and the water inlet(s) being associated with one or more capsule openers, such as capsule piercers;
at least one opener of said capsule opener(s) having an opening edge and a capsule opening direction along which said at least one opening edge and said capsule are relatively moved to open said capsule by the opening edge when said capsule is received by the first and second ingredient handlers,
at least one opener delimits a fluid passage located in the opening direction behind the opening edge, said beverage from said flavouring ingredient supplied within said capsule into the machine, the method comprising:
supplying the capsule between the first and second ingredient handlers in the ingredient transfer configuration;
relatively moving the first and second ingredient handlers with said capsule from the transfer configuration to the ingredient processing configuration;
opening the capsule with said one or more capsule openers associated with said one or more of the beverage outlet(s) and the water inlet(s) so that said at least one opener delimits a fluid passage located in the opening direction behind the opening edge of said at least one opener;
feeding said water via the water inlet into said capsule in the processing cavity and centrifuging the flavouring ingredient with the water and forming said beverage;
releasing the beverage from said capsule via the beverage outlet and the beverage passage; and
relatively moving the first and second ingredient handlers into the ingredient transfer configuration and evacuating said capsule.

15. (canceled)
